(19) United States
(12) Patent Application Publication
(10) Pub. No.: US 2015/0239086 A1
(43) Pub. Date: Aug. 27, 2015

(54) Electrical Power Safety System

(71) Applicant: Chao-Ying LEE, Reverside, CA (US)

(72) Inventor: Chao-Ying LEE, Reverside, CA (US)

(21) Appl. No.: 14/544,842

(22) Filed: Feb. 24, 2015

Related U.S. Application Data
(60) Provisional application No. 61/944,508, filed on Feb. 25, 2014.

(51) Int. Cl. B23Q 11/00; G05B 11/01; H02H 1/00

(52) U.S. Cl. CPC B23Q 11/0092; H02H 1/0007; G05B 11/01

(57) ABSTRACT

An electrical power safety system includes a system body having a user control terminal for receiving operational parameters for a power saw machine, a power management system including a control processor which is pre-programmed to manage the operation parameter communicating with the power saw machine and is used to generate an operation information, and a user interface, preferably connected to a display, for promptly and accurately communicating the operation information to an user on a real time basis. The system is capable of monitoring an operation task of the power saw machine, together with any accessory devices connected therewith, and providing a power supply in a usable form from any kind of power source to the power saw machine and the accessory devices. The system further includes a power control arrangement through which the speed of the power saw is controlled for convenience operation equipped with safety measures.

### CROSS REFERENCE OF RELATED APPLICATION

This is a non-provisional application that claims priority to U.S. provisional application No. 61/944,508, filed Feb. 25, 2014.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a power machine, and more particularly to an electrical power safety system for a power machine, for example a power saw machine, which is capable of managing and monitoring the different operational parameters of the power saw machine so as to allow a user of the present invention to optimally adjust the performance of the power saw machine and to maximize the quality of the resulting product.

2. Description of Related Arts

A conventional power machine, such as a power saw machine as an example, usually comprises a work table for a work piece disposed thereon, a saw blade suspendedly supported above the work table, and a power unit coupled with the saw blade for driving the saw blade to rotate at an extremely high speed for cutting the work piece on the work table. During a typical cutting process, the operator of the power saw machine has to manually control and monitor all the operational parameters thereof so as to obtain satisfactory cut on the work piece. For example, the operator has to monitor power unit, cooling fluid, control the speed at which the work piece moves with respective to the saw blade in order to successfully perform a regular cutting operation. The conventional power saw machine lacking a means to communicate with different mechanical devices not only fails to successfully control the saw blade to work effectively with different mechanical devices, but also fails to support the different mechanical devices or fix any operation abnormally during the operation.

There exists a number of disadvantages regarding the above mentioned conventional power saw machine. First, it is obvious that the above mentioned parameters are controlled by different mechanical devices which may or may not be directly associated with the mechanical hardware of the power saw machine. For example, the cooling fluid may be controlled by a pump not connected with the power saw machine itself. Moreover, the power supplied to the power unit may be controlled through a control panel of the power saw machine. Thus, the user has to simultaneously control many operational parameters for each single cutting process. All these components, especially electrical components, are separated from each other, cannot be centrally controlled. This is troublesome, inconvenient, and easy to cause industrial accidents.

Second, the convention power saw machine is not optimized to work efficiently with a variety of readily available conventional electrical safety devices, and if the operator chooses to purchase them separately may be discouraged by the financial burden required to purchase them.

Third, the conventional power saw machine does not specifically monitor and control the power input which is vital to safety and operation. Since the operation of the power saw machine requires a stable power source of a particular standard, failure to monitoring and control the power source will result in higher operation risk, lower durability and lower efficiency.

Forth, the conventional power saw machine is restricted to the use of one or more particular type of power source having a specific standard which is problematic where the power source supply as provided in the work place does not match the specific standard of the power saw machine. Also, the mobility of conventional power saw machine is limited to the availability of a particular power source with a particular standard.

### SUMMARY OF THE PRESENT INVENTION

An object of the present invention is to provide an electrical power safety system for a power machine, for example a power saw machine, which is capable of managing and monitoring the major operational parameters of the power saw machine so as to allow a user of the present invention to optimally control the power saw machine to maximize the quality of the resulting product.

Another object of the present invention is to provide an electrical power safety system which provides a connection and/or a communication platform to the power machine such that the power machine is capable of interactively connected to other devices.

Another object of the present invention is to provide an electrical power safety system which provides a connection and/or a communication platform to the power machine such that the power machine is able to connect to any power source through the system which is capable of monitoring and converting power source to a desired form. That is to say, the power saw machine is no longer limited from using one particular type and standard of power source which is necessary to the operation of the power machine but is capable of using power source of any type or standard with enhanced flexibility, effectiveness and efficiency.

Another object of the present invention is to provide an electrical power safety system which provides a connection and/or a communication platform to the power machine such that the power machine can provide power output to accessory devices such as water pump or mist pump having a different power input standard.

Another object of the present invention is to provide an electrical power safety system which provides a connection and/or a communication platform to the power machine such that the power machine is capable of using power from any power source, such as gas engine or electricity, while at the same time providing power output to accessory devices such as water pump or mist pump having a different power input standard through the electrical power safety system of the present invention.

Another object of the present invention is to provide an electrical power safety system comprising a power control arrangement which allows a wide range of power source input in different form and provides a wide range of power source output such that the mobility of the power machine and/or the accessory devices is highly increased without power supply limitation.

Another object of the present invention is to provide an electrical power safety system for a power machine which is capable of detecting a wide range of abnormal cutting condition for the power machine so as to avoid potential industrial accidents on the part of the user of the present invention. In other words, the electrical power safety system will detect the electrical problem of the power machine and notify the user how to repair the component of the power machine if malfunction occurs.

Another object of the present invention is to provide an electrical power safety system for a power machine which comprises a power management system and an interactive user interface provided on a system housing and electrically connected with the power management system for promptly and accurately communicating information from the power management system to a user of the power machine.

It can also shut off the power machine or reduce energy to the power unit once a preset value or condition determined to be harmful to the power machine or operator is detected. In other words, the electrical power safety system can use its ability to detect power flow to act as a smart circuit breaker, power regulator, shock preventer, magnetic power switch, i.e. amperage overload protection, accidental power start prevention, power leakage protection.

Another object of the present invention is to provide an electrical power safety system which is easy and convenient to use and support a wide variety of power machines, especially for power saw machines, so as to facilitate widespread application of the present invention. Accordingly, the electrical power safety system can incorporate with the power saw machine or hand saw to efficiently cut the work piece such as tile and masonry.

Additional advantages and features of the invention will become apparent from the description which follows, and may be realized by means of the instrumentalities and combinations particular point out in the appended claims.

Accordingly, in order to accomplish the above objects, the present invention provides an electrical power safety system for a power machine having a power tool, such as a saw blade, powered or driven by a power unit, comprising:

a system housing electrically connected with the power unit of the power saw, wherein the system housing comprises a control panel provided thereon for allowing a user to monitor an operational parameter through the control panel;

a power management system comprising a control processor mounted within the system housing to electrically communicate with the power machine, wherein the control processor is preprogrammed to manage or monitor the operational parameters of the power machine and supervise actual operation of the power machine and the power tool in such a manner that when abnormal operating condition of the power machine is detected, the control processor is adapted to selectively notify the operational parameters of the power machine for stopping the abnormal operating condition from continuously happening in order to ensure operation effectiveness and efficiency of the power machine while maintaining the maximum safety standard thereof; and

a user interface provided on the system housing and electrically connected with the power management system for promptly and accurately communicating information from the power management system to a user of the power machine.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an illustration of the electrical power safety system incorporated with an electric wet tile saw with a water pump according to the first preferred embodiment of the present invention.

FIG. 2 is a schematic diagram of the electrical power safety system according to the first preferred embodiment of the present invention.

FIG. 3 is a block diagram of the electrical power safety system according to the first preferred embodiment of the present invention.

FIG. 4 is a front view of the electrical power safety system according to the first preferred embodiment of the present invention, illustrate the display screen, and the control panel.

FIG. 5 is a front view of the electrical power safety system according to the first preferred embodiment of the present invention, illustrate a simplified display screen, and control panel.

FIG. 6 is an illustration of the electrical power safety system incorporating with an electric wet saw with a water pump or mist pressure pump according to the first preferred embodiment of the present invention.

FIG. 7 is an illustration of the electrical power safety system incorporating with an electric wet saw with a water pump or mist pressure pump according to the first preferred embodiment of the present invention.

FIG. 8 is a block diagram of an alternative of the electrical power safety system according to the second preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

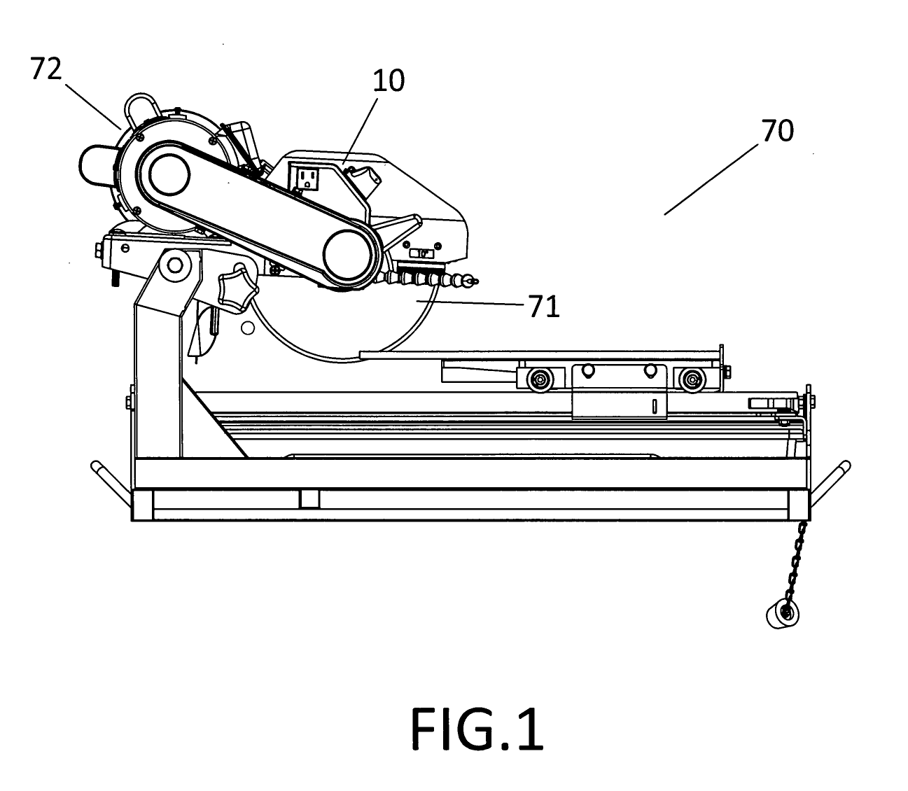

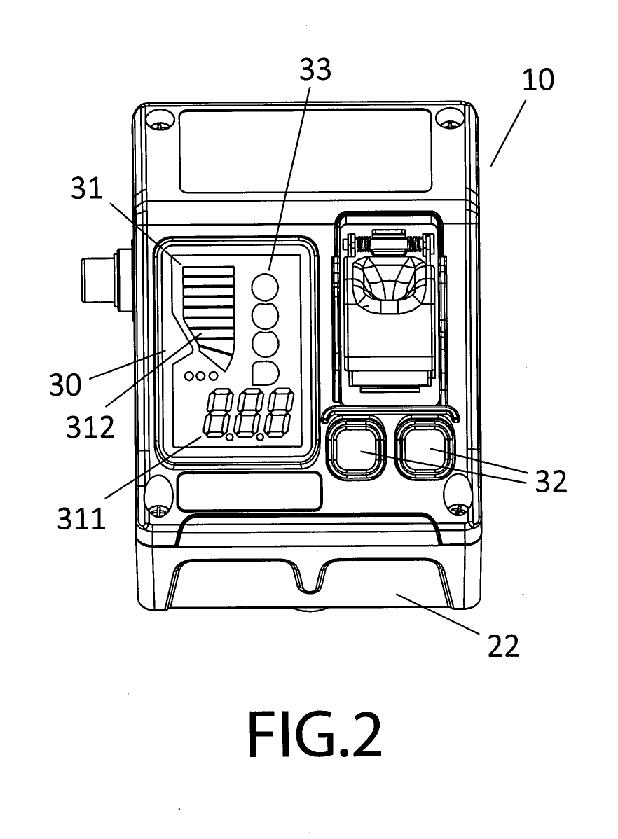

FIGS. 1 and 2 are illustrations of an electrical power safety system for a power machine embodied as a power saw machine 70 having a power tool embodied as a saw blade 71 powered and driven by a power unit 72 according to a preferred embodiment of the present invention is illustrated, in which the electrical power safety system comprises a system housing 10, a power management system and a user interface 30 according to the first preferred embodiment.

The system housing 10 is electrically connected with the power unit 72 of the power saw machine 70, wherein the system housing 10 comprises a control panel provided thereon for allowing a user to monitor an operational parameter through the control panel.

The user interface 30 comprises a display screen 31 provided on the system housing 10, as shown in FIG. 2 of the drawings, and electrically connected with the control processor for promptly and accurately displaying the operation of the power saw machine 70 and the accessory devices in a real time basis. The display screen 31 has a digit indicating section 311 and current indicator region 312 for indicating a proper condition of the power saw machine 70. When the power management system detects that the power saw machine 70 has improper working condition or proper working, letters or digits will illuminate or flash at the digit indicating section 311 to reflect condition thereof. The current indicator region 312 preferably contains a plurality of current sections, namely a low current section (designed to be 0 A-8 A), an optimal current section (designed to be 7 A-15 A), a high current section (designed to be 15 A to a threshold break current, which is designed to be 20 A) for indicating the real-time current drawn by the power saw machine 70. For example, when the power unit 72 is drawing 10 A current, corresponding illumination will be generated on the display screen 31 at the optimal current section so as to indicate to the user is the present invention that the power saw machine 70 is drawing a proper level of current. However, if the power saw machine 70 is drawing a current of 18 A, corresponding illumination will be generated on the display screen 31 at the high current section of the current indicator region 312. It is worth mentioning that at this point, even though the power saw machine 70 can still handle this load, the user of the present invention should reduce the current drawn by reducing the loading of the power saw machine 70 (such as by reducing a cutting feed rate of the work piece). Moreover, a visual warning (or audio) signal (in the form of illumination) will also be generated at the warning section of the display screen 31. In addition the user interface 30 has a section where important status LED's 33 will illuminate or flash such as power “PWR”, reset “RDT”, error “ERR”, etc. . . . to easily notify the user of a specific problem in order to quickly diagnose and fix problem.

The user interface 30 further comprises a plurality of functional buttons 32 on the system housing 10 for user preference setting, for example management of accessory device, and an audio warning device 22 for improper working condition audio warning or command confirmation audio.

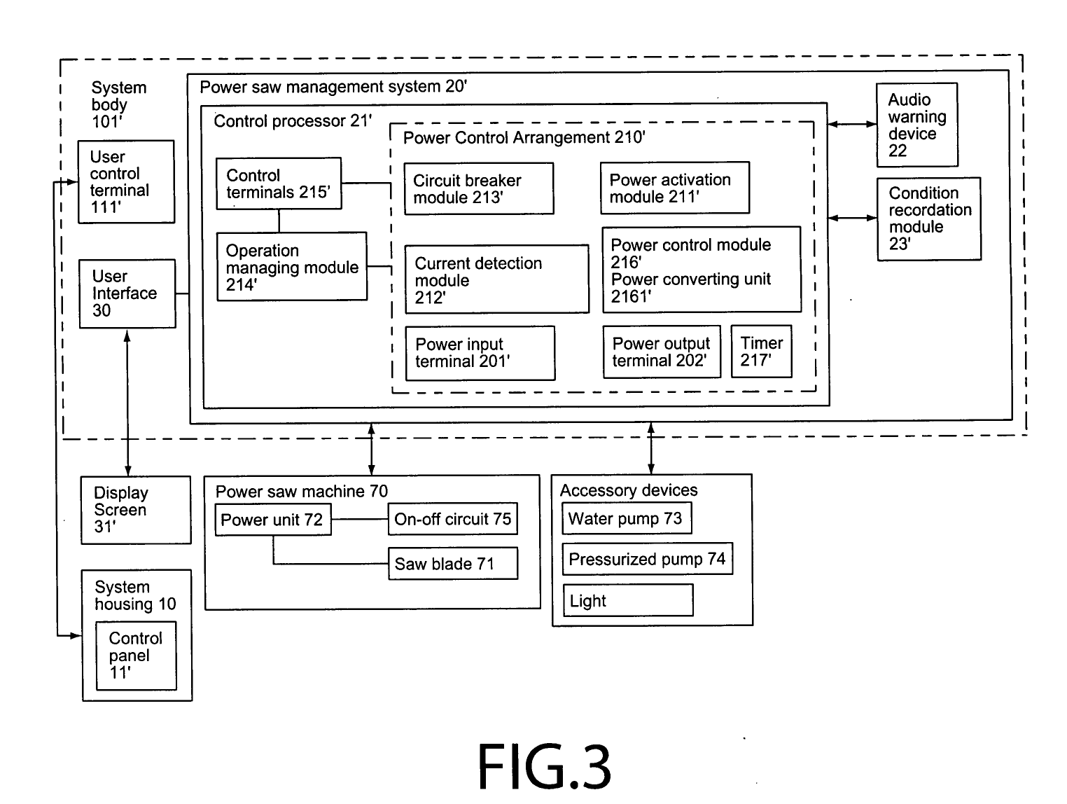

FIG. 3 is a block drawing of an electrical power safety system according to the first preferred embodiment of the present invention is illustrated. The electrical power safety system having a system body 101′ comprises a power management system 20′ and a user interface 30 which acted as a connection and communication platform for a power machine embodied as a power saw machine 70 comprising a power tool embodied as a saw blade 71 and a power unit 72 powering and driving the saw blade 71. The electrical power safety system further comprises a user control terminal 111′ on the system body for receiving one or more operational parameters from a user.

The electrical power safety system can be embodied in a system housing 10 comprising a control panel 11′ provided thereon, wherein the control panel 11′ is electrically connected to the user control terminal 111′ such that a user is allowed to monitor the operational parameter through the control panel 11′ connecting to a user control terminal 111′.

Alternately, the electrical power safety system can be integrally incorporated into the power saw machine 70, wherein the user control terminal 111′ is used to monitor the operational parameter. It is worth mentioning that the electrical power safety system is modular in design and does not rely on the power saw machine 70 to function for providing integration flexibility. That is to say, the electrical power safety system can be easily mounted to any power saw machine or power tool (accessory device) and can be integrated into the body of a power saw machine or power tool, thus providing design flexibilities for aesthetic or practical reasons.

The power management system 20′ is capable of electrically connected or communicated to one or more accessory devices such as a fluid pump, a light, a water pump 73 and a pressurized pump 74 such that the operation of the accessory devices can be monitored and adjusted simultaneously with the power saw machine 70. In other words, the operation of the power saw machine together with the accessory devices is controlled by the power management system 20′. That is to say, the every single cutting operation is comprehensively managed and supervised.

The power management system 20′ comprises a control processor 21′ electrically communicate with the power saw machine 70, wherein the control processor 21′ is pre-programmed to manage the operational parameters of the power saw machine 70 and supervise actual operation of the power saw machine 70 and the saw blade 71 in such a manner that when abnormal operating condition of the power saw machine 70 is detected, the control processor 21′ is adapted to alert the user and selectively notify the operational parameters of the power saw machine 70 for preventing the abnormal operating condition from continuously happening in order to ensure operation effectiveness and efficiency of the power saw machine 70 while maintaining the maximum safety standard thereof.

Particularly, the control processor 21′ is preprogrammed to generate an operation information representing the current status of the power saw machine 70 and an accessory information representing the current status of the accessory device connected therewith. When an abnormal condition is determined, a warning message, which may also include an accessory warning message, will be generated to notify the user. The power management system 20′ further comprises an audio warning device 22 electrically connect with the control processor 21′ for generating audio warning signals when necessary. That is, when improper working condition of the power saw machine 70 is detected and user attention is urgently needed.

The power control arrangement can prevent any undesired operation of the power saw machine 70 such as an overloaded operation, wherein the power control module 216′ interactively communicates between the current detection module 212′, the control terminals 215′ and the power saw machine 70. In response to the current status from the current detection module 212′ reflecting an overload operation in which the power consumption is abnormally high or the current detected is abnormal, the power control module 216′ will manipulate power accordingly or the power activation module 211′ will disconnect the power source. As a result, the power unit 72 can be unpowered stopping the saw blade 71. The above safeguard as provided by the power control arrangement not only prolongs the life of the power saw machine in taking into account of the whole operation condition which includes temperature, load, etc. of the power unit 72 such that the power saw machine 70 is protected as a whole, but also protect the user. The current first embodiment relays power abnormality through the user interface 30 in such a way that the user can easily fix in order to reset the electrical power safety system, increasing efficiency. For example, a power leak will illuminate the status LED's 33 with the label PWR and then power activation module 211′ will disconnect power to the power unit 72, but not necessarily in this order. The user by being properly informed of the power saw machine's current operating condition can expedite the repair process, then can reset the electrical power safety system. The current first embodiment resets the system by the user toggling the on-off circuit 75 to the OFF position and then back to the ON position to restore power. In doing so prompts the power control arrangement 210′ to recheck the system for abnormalities before power is sent to the power unit 72 once again.

The current first embodiment current detection module 212′ will also communicate to the power activation module 211′ not to send power to the power saw machine if power fed into the power input terminal 201′ was disrupted and the on-off circuit 75 was left in the ON position. If the user leaves the power saw machine unattended to diagnose the power source problem, a sudden return of power will cause abrupt activation of the saw machine causing a possible industrial accidental. The system has to be reset manually for the electrical power safety system to allow power to flow unimpeded to the power saw machine.

It is worth mentioning that compared to the use of only a typical breaker which will not take into account the whole operation condition to cutting off power supply to the power unit such as a motor or a motor engine, or compared to the use of a thermal sensor in the motor interpreting overload as overheat, that is a temperature higher than the threshold value, which is then detected by the sensor such that the power saw machine is turned off and cannot be turned on until the sensor detects a lowered temperature lower than the threshold value, the use of the power control arrangement to manipulate the power supply to the power unit 72 provides two important properties to the power saw machine 70. First, consistently cuts off power to pre-set numerical value regardless of any factors the power control arrangement 210′ may experience such as heat or use over time. For example, 15 A circuit breaker cuts off power supposedly at 250% rated amp value, but if hot could cut off power at 200% rated amp value. The system if pre-set to cut power at 25 A will always cut off power at 25 A since it relies on the current detection module 212′ not any mechanical components.

The electrical power safety system according to the first embodiment of the present invention further comprises at least one power input terminal 201′ and one power output terminal 202′ provided on the power management system 20′. The power input terminal 201′ is adapted for electrically connecting to a power source to receive power there from while the power output terminal 202′ is adapted for electrically connecting to a power tool to provide power to the power tool such as a power saw machine and a fluid pump.

The power control module 216′ of the power control arrangement 210′ further comprises a power converting unit 2161′ electrically connected to the power input terminal 201′ and the power output terminal 202′ respectively, wherein the power converting unit 2161′ is capable of converting power from an unconverted form to a converted form. For example, the power converting unit 2161′ is able to convert an AC power from a gas engine to a DC power for use by a power tool such as a water pump. In other words, the power control arrangement 210′ provides a means to convert power from an unconverted form to a converted form such that the electrical power safety system is capable of taking power from any power source and converting it to a converted form for use by the system itself or for use by any accessory devices or power tools connected therewith. It is worth mentioning that the power supply in the unconverted form, which is best demonstrated by the gas engine of smaller capacity with low voltage output, is not usable by many electric devices due to problems ranging from AC/DC incompatibility, power fluctuation, power spikes, incorrect voltage, etc. In other words, the power generator of the power saw system can be the gas engine, the AC electric motor, or the DC electric motor being operatively linked to the power converting unit 2161′ to convert the input power into a stable and useful output power. Therefore, the means to convert power from an unconverted form to a converted is important for the following reasons. First, convenience power source, such as a gas engine from a vehicle, can be used to generate power for the power saw machine and the accessory devices. Second, the mobility and flexibility of the power saw machine and the accessory devices are highly increased, which is especially important in construction area or remote area with limited power source. Third, the controlled power output to the power saw machine and the accessory devices integrates the cutting operation through the electrical power safety system which improve the durability of the power saw machine and the accessory devices. Forth, through the power control arrangement, a set of saw data representing the behavior of the power saw machine can be obtained through calculation of power. It is worth mentioning that the power unit 72 can be integrated with the power generator to form a single unit structure for powering the power tool mechanically via belt or electronically, wherein the power unit 72 generates power for the converter in the electrical power safety system. In other words, the power unit 72 can be gas powered.

In a testing of the electrical power safety system on the power saw machine 70, an engine is used as a power source and power unit 72 to drive the saw blade 71. Since the AC power from the engine provides a relatively low voltage, only DC electrical pump can be used to handle the low voltage while providing the desired water flow for the power saw machine. However, the DC electrical pump requires an accurate power flow or will be damaged. The testing results showed that the power flow is stabilized and controlled at a constant level within an accurate range through the electrical power safety system of the present invention. That is to say, the DC electrical pump can be operated under its optimal condition in connection with the power saw machine with the use of an unstable low voltage power source. Moreover, through the monitoring of power input of the motor or output of the engine, the rotational speed of the saw blade which is directly proportional to the power outputted by the engine can be measured.

The increased mobility, flexibility and durability of the power saw machine and the accessory devices, together with the availability of the saw data has provided one great advantage to facilitate the rental business of the power saw machine 70. Through the calculation of power of the power saw machine with the power management system 20′, the usage of the accessory device of the power machine can be determined through the power control arrangement of the control processor 21′. In other words, a saw usage of the power saw machine 70 in terms of rotation over a period of time such as rotation per minute (rpm) can be determined. That is to say, the saw usage in rpm can be used in the rental business of the power saw machine as an example. Alternately, the power saw management 20′ further comprises a timer unit 217′ for calculating the saw usage in term of time, such as the time of power on or the time of performing cutting task. It is worth mentioning that the saw usage may be calculated based on the power consumption of the saw machine, the time unit, their derivatives or their combination. Therefore, the commercial utility for the power saw machine equipped with the electrical power safety system according to the preferred embodiment of the present invention has greatly increased.

The power control arrangement further comprises a power activation module 211′ electrically communicated with the on/off circuit 75 of the power saw machine 70 for shutting off the power saw machine 70. Preferably, the power activation module 211′ is electrically communicated with the on/off circuit of the power saw machine 70 and any accessory device connected therewith for selectively activating and deactivating the power saw machine 70 and the corresponding accessory device connected therewith. When two or more accessory devices are connected, the power activation module 211′ is capable of selectively and individually controlling the activation or deactivation of the accessory devices.

The power control arrangement may further comprises a circuit breaker module 213′ electrically connected with the power saw machine 70 in such a manner that when the threshold break current as detected by the current detection module 212′ has been reached for a predetermined period of time, the circuit breaker module 213′ is activated to turn off the power saw machine 70 so as to avoid any accident which may have occurred due to overload of the power saw machine 70.

The user interface 30 is electrically connected to the control processor 21′ of the power management system 20′ for promptly and accurately communicating information from the power management system 20′ to a user of the power saw machine 70. The user interface 30′ further comprises a display screen 31′ electrically connected with the control processor 21′ and promptly and accurately displaying the operation of the power saw machine 70 and any accessory devices connected therewith on a real time basis.

The power management system 20′ further comprises a condition recordation module 23′ communicatively linked to the control processor 21′ for recording an operation condition of the power saw machine 70. Accordingly, the condition recordation module 23′ will keep recording the current condition of the power saw machine 70 including the statuses of the accessory devices and the current detected from the current detection module 212′. The condition recordation module 23′ contains data to explain the reason the power saw machine 70 failed, the resulting diagnosis, and the actions taken by the system of the present invention. For example, when the power of the power saw machine 70 is deactivated by the power activation module 211′ due to the failure operation of an accessory device, the fluid pump (such as a water pump), the condition recordation module 23′ will record and show the reason of the failure operation of the power saw machine 70. Therefore, the user is able to trace the problem of the power saw machine 70 through the condition recordation module 23′. In addition, the records in the condition recordation module 23′ will diagnose whether the power saw machine 70 is being misused, such as constant overloading of the power unit 72, or not.

It is worth mentioning that the electrical power safety system of the present invention can be an external diagnostic device as an add-on device to electrically couple between the power source and the power saw machine 70. As an add-on device, the user may still operate the power saw machine 70 even if the electrical power safety system of the present invention fails. The electrical power safety system can also be formed as an internal diagnostic device that the electrical power safety system is built-in with the power saw machine 70.

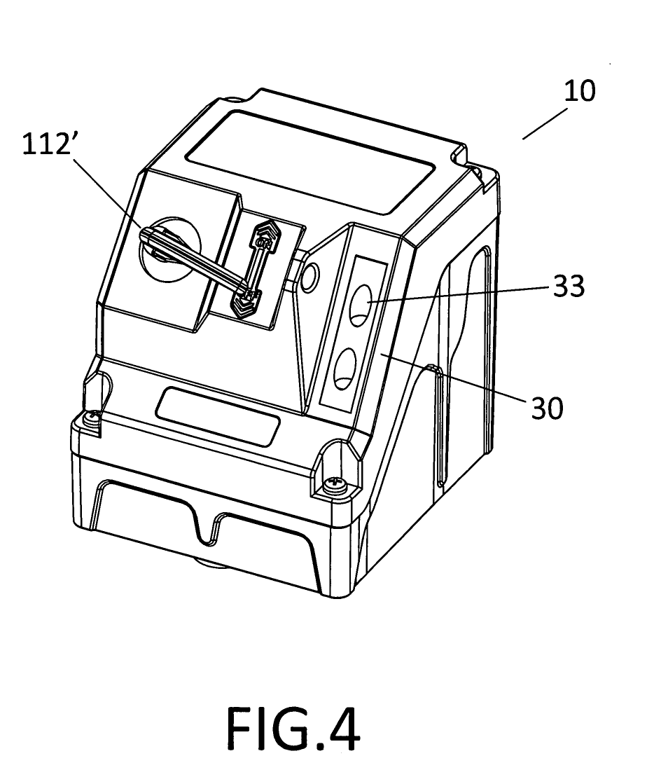

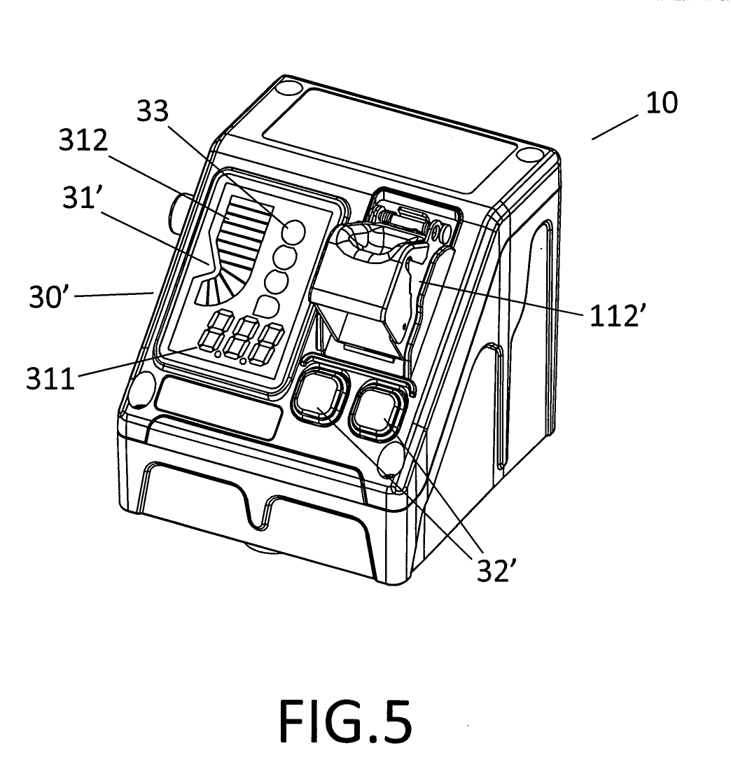

FIGS. 4 and 5 are illustrations of the electrical power safety system with different types of system housing 10 according to the first preferred embodiment. As shown in FIG. 4, the system housing has been simplified so that the display screen 31′ shows limited selective operation parameters to suit the requirements of the user. A more comprehensive display as show in FIG. 5, where the system housing can be arranged so that the display screen 31′ has a digit indicating section 311 for indicating a proper condition of the power saw machine 70 as a digital display, and a current indicator region 312 formed thereon for displaying the current drawn by the power unit 72 so as to form an ammeter display. The system housing 10 of FIG. 5 further comprise of a user interface 30′ further comprises with a plurality of functional buttons 32′ on the system housing 10 for user preference setting, such as pump control and light control. It is worth mentioning that the display screen 31′ can be a LED touch screen to display and select different information from the power management system 20′, such as reset, light, pump, and power information.

It is worth mentioning that the on-off toggle switch 112′ functions not only as a power switch, but also a reset button. Should the electrical power safety system need to be reset due to an emergency shutdown by the power saw management system 20′, the user must toggle the on-off toggle switch 112′ to the OFF position and back to the ON position. For example, the detection of a power leak by the current detection module 212′ will prompt automatic power shut down by the power activation module 211′ and a warning will be shown on the warning section of the display screen 31′. The user although fixes the problem must still put the on-off toggle switch 112′ to the OFF position and then to the ON position to restart the power unit 72, thereby increasing safety and efficiency by removing the need for an additional reset button to monitor.

It is worth mentioning that the first preferred embodiment of the present invention, the control processor 21′ comprises a power control arrangement 210′ for controlling the power input and output of the power saw machine, one or more control terminals 215′ to electrically couple with one or more accessory devices and an operation managing module 214′ performing preliminary diagnostic examination on the power saw machine and any accessory devices connected therewith.

The operation managing module 214′ is electrically connected to the power saw machine 70 which will become active once the power saw machine 70 is plugged into a power source, wherein the power saw machine 70 does not have to be turned on. The operation managing module 214′ will automatically perform a preliminary inspection to detect any possible error on basic operation parameters and go into a standby mode after a self system check is completed. A failed check is immediately shown on the warning section of the display screen 31′ and the power control arrangement 210′ will not allow the system to be turned on until fixed.

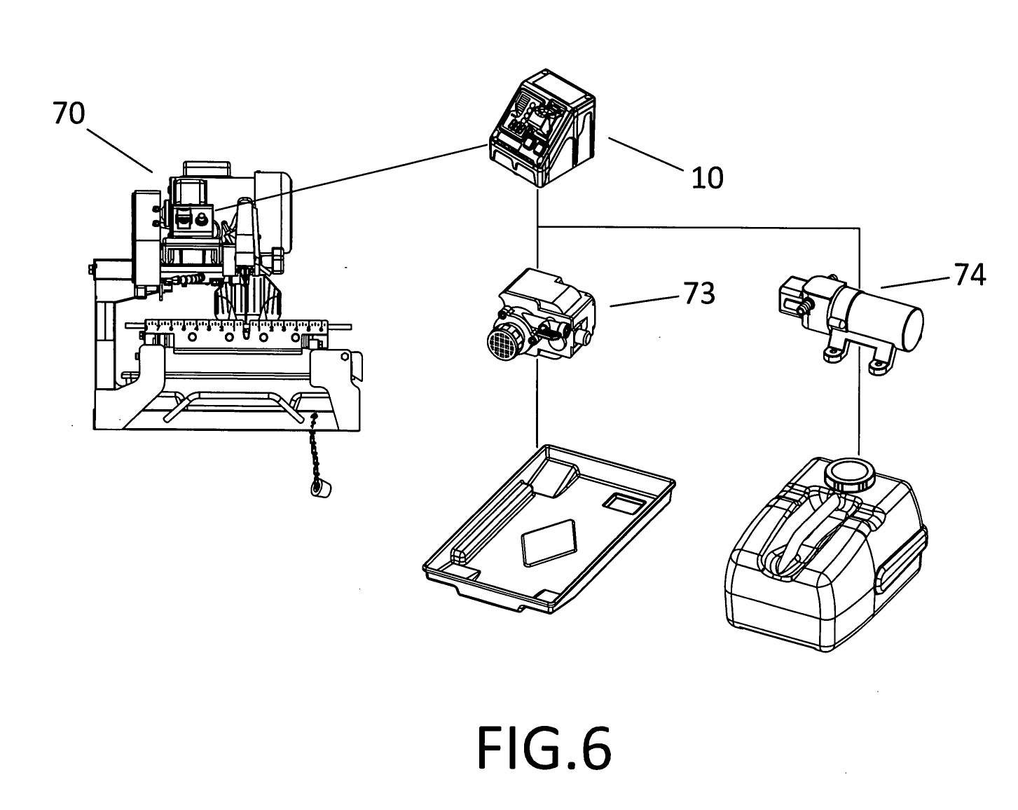

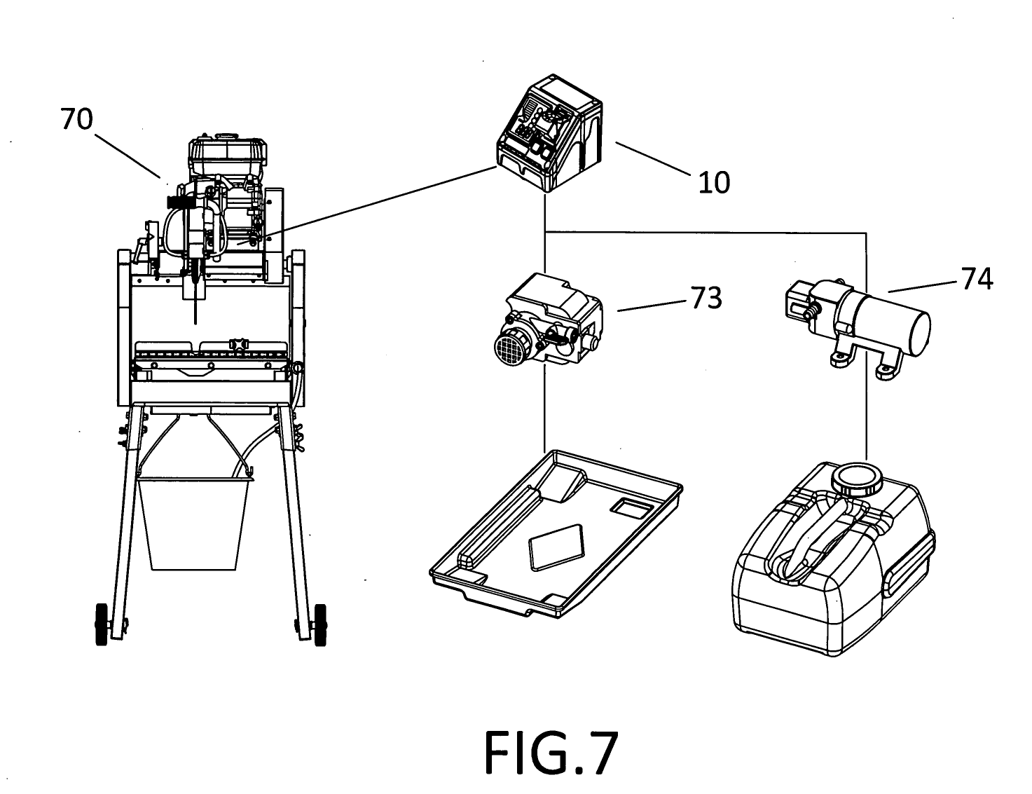

FIGS. 6 and 7 are illustrations of the electrical power safety system incorporated with different types of power saw machine 70 with different type of accessory devices such as different kinds of pump. As shown in FIG. 6, the electrical power safety system can be incorporated with an electric wet power saw machine with the water pump 73. As shown in FIG. 7, the electrical power safety system can be incorporated with a gas power saw machine with the water pump 73 or the mist pressure pump 74. As shown in FIG. 6, the electrical power safety system can be incorporated with a gas engine masonry saw with the pressure water pump 74.

It is appreciated that the electrical power safety system is adapted not only to monitor the operational parameters of the power saw machine 70 but also to controllably adjust the operational parameters of the power saw machine 70 via the control panel 11′. Accordingly, the control processor 21′ can manage the operational parameters of the power saw machine 70 and supervise the actual operation of the power saw machine 70 in such a manner that when the abnormal operating condition of the power saw machine 70 is detected, the control processor 21 is adapted to selectively adjust the operational parameters of the power saw machine 70 for stopping the abnormal operating condition from continuously happening in order to ensure operation effectiveness and efficiency of the power saw machine 70 while maintaining the maximum safety standard thereof.

It is appreciated that the light can be electrically connected with the electrical power safety system as one of the accessory devices of the power saw machine 70 such that the electrical power safety system can control the on-and-off operation of the light and monitor the operation of the light regardless if the power saw machine 70 is on or off. In other words, the diagnosing method of the pump of the power saw machine 70 can be applied to the diagnosing method of the light.

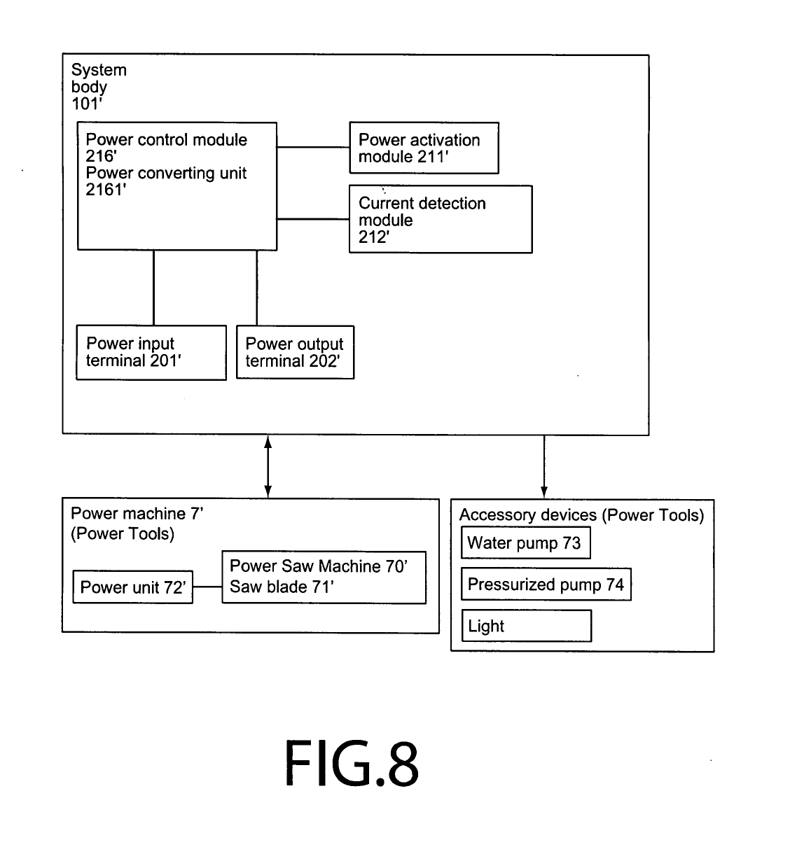

FIG. 8 It is worth mentioning that an alternative of the electrical power safety system of the present invention for a power machine having a power tool powered by a power unit, as shown, comprises a system body 101′ comprising a power input terminal 201′ for electrically connecting to a power source, and power output terminal 202′ for electrically connecting to a power tool 7′, and a power converting unit 2161′ electrically connected between the power input terminal 201′ and the power output terminal 202′ for converting power from an unconverted form to a converted form for the power tool. The system also comprises a power control module 216′, a current detection module 212′ and a power activation module 211′. The power control module 216′ is arranged to monitoring a power supply to the power unit of the power machine and may integrally incorporate with the power converting unit 2161′. The current detection module 212′ is electrically communicated with the power control module 216′ for electrically connected with the power machine 7′ to detect the electric current drawn by the power unit 72′ of the power machine 7′ to obtain a current status. The power activation module 211′ is electrically communicated with the power machine 7′ for shutting off the power machine 7′ when the power machine 7′ is overloaded, or disconnects power to say power machine when said current status or electrical condition determined to be harmful to the power machine or operator is detected. Accordingly, power in the unconverted form which is unusable by the power tools is transformed by the system of the present invention into the converted form which is usable by the power tools such as water pump 73, pressurized pump 74 and lighting fixture. That is to say, the system of the present invention allows the power machine 7′ to make use of any available power source such as diesel, petroleum oil, or electrical power source to meet the peculiar requirements of different power tools. The available power source such as gas engine can be used to drive both the power saw machine and the accessory devices.

For example, when a power saw machine 70′ having a saw blade 71′ is used together with a water pump 73, a rotational speed of the saw blade 71′ is arranged to be controlled by the power control module 216′ and the power activation module 211′ which is electrically communicated with the power machine 7′ is arranged to shutting off the power saw machine 70′ after the rotational speed of the saw blade 71′ is controlled to be decreased for an extended period of time. The water pump which is powered through the power converting unit 2161′ is then turned off for lack of power. In addition, the power control module 216′ may further generate a saw usage of the power saw machine by recording the usage of power through the power output terminal 202′.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An electrical power safety system for a power machine having a power tool powered by a power unit, comprising:
a system body having a user control terminal adapted for receiving one or more operational parameter for the power machine;
a power management system, provided on said system body, comprising a control processor for electrically connecting to the power machine, wherein said control processor is pre-programmed to manage said operational parameter for the power machine and is adapted for generating an operation information of the power machine, wherein when said operational parameter of the power machine is determined to be under an abnormal condition, a warning message is corresponding generated for promptly and accurately notifying a user on a real time basis; and
a user interface electrically connected to said control processor of said power management system for promptly and accurately communicating the operation information to a user.

2. The electrical power safety system, as recited in claim 1, further comprising a power input terminal for electrically connecting to a power source, and power output terminal for electrically connecting to the power tool, wherein said power management system further comprises a power converting unit electrically connected between said power input terminal and said power output terminal for converting power from an unconverted form to a converted form for the power tool.

3. The electrical power safety system, as recited in claim 1, wherein said power control arrangement further comprises a power control module monitoring a power supply to a power unit of the power machine for controlling a rotational speed of the saw blade for being overloaded.

4. The electrical power safety system, as recited in claim 2, wherein said power control arrangement further comprises a power control module monitoring a power supply to a power unit of the power machine for controlling a rotational speed of the saw blade for being overloaded.

5. The electrical power safety system, as recited in claim 3, wherein said power control arrangement further comprises a current detection module electrically communicated with said power control module for electrically connected with the power machine to detect the electric current drawn by the power unit of the power machine to obtain a current status.

6. The electrical power safety system, as recited in claim 4, wherein said power control arrangement further comprises a current detection module electrically communicated with said power control module for electrically connected with the power machine to detect the electric current drawn by the power unit of the power machine to obtain a current status.

7. The electrical power safety system, as recited in claim 1, wherein said power management system further comprises a power activation module electrically communicated with the power machine for shutting off the power machine after the rotational speed of the saw blade is controlled to be decreased for an extended period of time or detection of abnormal electrical situation.

8. The electrical power safety system, as recited in claim 4, wherein said power management system further comprises a power activation module electrically communicated with the power machine for shutting off the power machine after the rotational speed of the saw blade is controlled to be decreased for an extended period of time or electrical condition determined to be harmful to the power machine or operator is detected.

9. The electrical power safety system, as recited in claim 6, wherein said power management system further comprises a power activation module electrically communicated with the power machine for shutting off the power machine after the rotational speed of the saw blade is controlled to be decreased for an extended period of time or electrical condition determined to be harmful to the power machine or operator is detected.

10. The electrical power safety system, as recited in claim 2, wherein said control processor generates a saw usage of the power machine by the usage of power through said power output terminal.

11. The electrical power safety system, as recited in claim 9, wherein said control processor generates a saw usage of the power machine by the usage of power through said power output terminal.

12. A power saw system for coupling with at least one accessory device, comprising:
a power saw machine comprising a saw blade, a power unit for driving said saw blade, and an on/off circuit electrically connected with said power unit for providing a shutting off safeguard to said power saw machine; and
an electrical power safety system, which comprises:
a system body having a user control terminal arranged for receiving one or more operational parameter for the power saw machine;
a power management system, provided on said system body, comprising a control processor for electrically connected to the power saw machine, wherein said control processor is pre-programmed to manage the operational parameter for the power saw machine and is arranged for generating an operation information of said power saw machine, wherein when said operational parameter of the power saw machine is determined to be under an abnormal condition, a warning message is corresponding generated for promptly and accurately notifying a user on a real time basis; and
a user interface electrically connected to said control processor of said power management system for promptly and accurately communicating said operation information and said accessory information to a user.

13. The power saw system, as recited in claim 12, wherein said electrical power safety system further comprises a power input terminal for electrically connecting to a power source, and a power output terminal for electrically connecting to said accessory device, wherein said power management system further comprises a power converting unit electrically connected between said power input terminal and said power output terminal for converting power from an unconverted form to a converted form for the accessory device.

14. The power saw system, as recited in claim 13, wherein said power saw machine is incorporated with a power generator operatively linked to said power converting unit, wherein said accessory device is selected from the group consisting of electric water pump, pressurized pump, and light.

15. The power saw system, as recited in claim 12, wherein said power control arrangement further comprises a power control module monitoring a power supply to a power unit of the power saw machine for controlling a rotational speed of the saw blade for being overloaded.

16. The power saw system, as recited in claim 14, wherein said power control arrangement further comprises a power control module monitoring a power supply to a power unit of the power saw machine for controlling a rotational speed of the saw blade for being overloaded.

17. The power saw system, as recited in claim 12, wherein said power management system further comprises a power activation module electrically communicated with the power saw machine for shutting off the power saw machine after the rotational speed of the saw blade is controlled to be decreased for an extended period of time or electrical condition determined to be harmful to the power machine or operator is detected.

18. The power saw system, as recited in claim 16, wherein said power management system further comprises a power activation module electrically communicated with the power saw machine for shutting off the power saw machine after the rotational speed of the saw blade is controlled to be decreased for an extended period of time or electrical condition determined to be harmful to the power machine or operator is detected.

19. The power saw system, as recited in claim 12, wherein said control processor generates a saw usage of the power saw machine by the usage of power through said power output terminal.

20. The power saw system, as recited in claim 18, wherein said control processor generates a saw usage of the power saw machine by the usage of power through said power output terminal.

21. A method of digitalizing a power machine including at least an accessory device and a power unit powering the accessory device, comprising the steps of:
(a) providing an electrical power safety system which comprises a system body having a user control terminal receiving one or more operational parameter for said power machine;
(b) monitoring said operation parameter of said power machine via a control processor of said electrical power safety system;
(c) generating a warning signal when said operation parameter of said power machine indicates an abnormal condition; and
(d) promptly and accurately communicating said operation parameter of said power machine through a user interface of said electrical power safety system.

22. The method, as recited in claim 20, wherein the step (c) further comprises the steps of:
(c.1) receiving a power source from an unconverted form;
(c.2) converting said power source into a desired form for said power machine; and
(c.3) converting said power source into a desired form for said accessory device.

23. The method, as recited in claim 21, wherein the step (b) further comprises a step of monitoring said accessory device in connection with said power machine, and the step (c) further comprises a step of detecting an accessory information of said accessory device and indicates an abnormal condition.

24. The method, as recited in claim 22, wherein the step (b) further comprises a step of monitoring said accessory device in connection with said power machine, and the step (c) further comprises a step of detecting an accessory information of said accessory device and indicates an abnormal condition.

25. The method, as recited in claim 22, wherein the step (b) further comprises the steps of:
(b.1) obtaining a current status through a current detection module for current detection;
(b.2) determining said power source to said power machine in response to said current status;
(b.3) decreasing said power source to said power machine when said current status obtained attains a threshold value for a period of time, such that a working condition of said accessory device is adjusted; and
(b.4) disconnecting said power source to said power machine when said current status or electrical condition determined to be harmful to the power machine or operator is detected.

26. The method, as recited in claim 24, wherein the step (b) further comprises the steps of:
(b.1) obtaining a current status through a current detection module for current detection;
(b.2) determining said power source to said power machine in response to said current status;
(b.3) decreasing said power source to said power machine when said current status obtained attains a threshold value for a period of time, such that a working condition of said accessory device is adjusted; and
(b.4) disconnecting said power source to said power machine when said current status or electrical condition determined to be harmful to the power machine or operator is detected.

27. The method, as recited in claim 21, further comprising a step of determining a usage of said accessory device of the power machine through a power control arrangement of said control processor.

28. The method, as recited in claim 26, further comprising a step of determining a usage of said accessory device of the power machine through a power control arrangement of said control processor.

29. The method, as recited in claim 21, further comprising a step of communicatively connecting said user interface to a network such that said operation information of said power machine and said accessory information of said accessory device is capable of being transmitted through said network to a desired location.

30. The method, as recited in claim 28, further comprising a step of communicatively connecting said user interface to a network such that said operation information of said power machine and said accessory information of said accessory device is capable of being transmitted through said network to a desired location.

31. A method of diagnosing a power saw machine via an electrical power safety system, comprising the steps of:
(a) activating said electrical power safety system at a stand-by mode when said power saw machine is electrically connected to a power source, wherein at said stand-by mode, said electrical power safety system performs a self diagnose and measures voltage level of said power source; and
(b) switching on said power saw machine through said electrical power safety system to manage operational parameters of said power saw machine and supervise actual operation of said power saw machine and a saw blade thereof in such a manner that when abnormal operating condition of said power saw machine is detected, said electrical power safety system is adapted to selectively notify said operational parameters of said power saw machine for stopping said abnormal operating condition from continuously happening in order to ensure operation effectiveness and efficiency of said power saw machine while maintaining the maximum safety standard thereof.

32. The method, as recited in claim 31, wherein the step (b) further comprises a step of generating a warning signal when said abnormal operating condition of said power saw machine is detected.

33. The method, as recited in claim 32, wherein the step (a) further comprises the steps of:
(a.1) receiving a power source from an unconverted form;
(a.2) converting said power source into a desired form for said power saw machine; and
(a.3) converting said power source into a desired form for an accessory device of said power saw machine.

34. The method, as recited in claim 33, wherein the step (b) further comprises a step of monitoring said accessory device in connection with said power machine, and detecting an accessory information of said accessory device and indicating an abnormal condition.

35. An electrical power safety system for a power machine having a power tool powered by a power unit, comprising:
a system body comprising a power input terminal for electrically connecting to a power source, and power output terminal for electrically connecting to a power tool, and
a power converting unit electrically connected between said power input terminal and said power output terminal for converting power from an unconverted form to a converted form for the power tool.

36. The system, as recited in claim 35, further comprising a power control module monitoring a power supply to the power unit of the power machine.

37. The system, as recited in claim 36, further comprising a current detection module electrically communicated with said power control module for electrically connected with the power machine to detect the electric current drawn by the power unit of the power machine to obtain a current status.

38. The system, as recited in claim 37, wherein the power tool is a power saw machine having a saw blade of which a rotational speed is controlled by said power control module, further comprising a power activation module electrically communicated with the power machine for shutting off the power machine after the rotational speed of the saw blade is controlled to be decreased for an extended period of time or electrical condition determined to be harmful to the power machine or operator is detected.

39. The system, as recited in claim 38, further comprising a control processor generates a saw usage of the power saw machine by the usage of power through said power output terminal.
